(19) United States
(12) Patent Application Publication
(10) Pub. No.: US 2026/0206842 A1
(43) Pub. Date: Jul. 23, 2026

(54) AEROSOL-GENERATING DEVICE WITH REMOVABLE BATTERY, SYSTEM COMPRISING SUCH DEVICE AND BATTERY REPLACEMENT METHOD FOR SUCH DEVICE

(71) Applicant: Philip Morris Products S.A., Neuchatel (CH)

(72) Inventor: Sander BROUWER, Lausanne (CH)

(73) Assignee: Philip Morris Products S.A., Neuchatel (CH)

(21) Appl. No.: 19/139,471

(22) PCT Filed: Nov. 20, 2023
(86) PCT No.: PCT/EP2023/082336

§ 371 Date: Jun. 16, 2025

(30) Foreign Application Priority Data
Dec. 30, 2022 (EP) 22217416.1

(51) Int. Cl. A24F 40/40; A24F 40/20; A24F 40/90; H02J 7/70

(52) U.S. Cl. CPC A24F 40/40; A24F 40/90; H02J 7/731; A24F 40/20

(57) ABSTRACT

An aerosol-generating device is provided, including: a power supply configured to supply power for operation of the device to generate an aerosol and including a battery compartment to removably hold a battery; an aerosol-generating compartment including an aerosol-generating-article-receiving cavity to removably receive an aerosol-generating article; and two removably attachable housing portions to be selectively arranged in an attached state or a detached state, a first housing portion to accommodate the power supply and the compartment, a second housing portion being a removable cap to secure the compartment within the first portion in the attached state, in which transferring the housing portions from the attached to detached state enables replacement of the battery, and the removable cap having a form of a ring element with an opening to access the cavity in the attached state.

### TECHNICAL FIELD

The present invention relates to an aerosol-generating device comprising a power supply unit, configured to supply power for operation of the aerosol-generating device to generate an aerosol, wherein the power supply unit comprises a battery, wherein the aerosol-generating device further comprises a housing comprising the power supply unit as well as an aerosol-generating article-receiving cavity for removably receiving an aerosol-generating article. The present invention also relates to a system comprising the aerosol-generating device, and a battery replacement method for the aerosol-generating device. The present invention further relates to a use of removably attachable housing portions in an aerosol-generating device.

### BACKGROUND

One type of aerosol-generating system is an electrically operated smoking system. Known handheld electrically operated smoking systems typically comprise an aerosol-generating device comprising a rechargeable battery, control electronics and an electric heater for heating an aerosol-generating article designed specifically for use with the aerosol-generating device. In some examples, the aerosol-generating article comprises an aerosol-forming substrate, such as a tobacco rod or a tobacco plug, and the heater contained within the aerosol-generating device is inserted into or located around the aerosol-forming substrate when the aerosol-generating article is inserted into the aerosol-generating device. In an alternative electrically operated smoking system, the aerosol-generating article may comprise a capsule containing an aerosol-forming substrate, such as loose tobacco.

In known electrically operated smoking systems the batteries are inseparably integrated into the housing of the aerosol-generating device or are installed in such a way that they can only be removed from same with high effort. As a consequence, users tend to throw away the entire aerosol-generating device, including the battery, as soon as the battery has reached the end of life, even though the device as such would still be functional. This on the one hand creates unnecessary waste and on the other hand makes it difficult to recycle the materials used in the batteries, such as mercury or cadmium.

In view of the above, it would be desirable to provide an aerosol-generating device that minimizes the waste associated with ageing batteries for operating the aerosol-generating device, thus contributing to the protection, preservation and improvement of the quality of the environment.

### SUMMARY

According to a first aspect of the invention, there is provided an aerosol-generating device comprising: a power supply unit, configured to supply power for operation of the aerosol-generating device to generate an aerosol, wherein the power supply unit comprises a battery compartment for removably holding a battery, and a housing comprising the power supply unit as well as an aerosol-generating article-receiving cavity for removably receiving an aerosol-generating article.

In this aerosol-generating device, the battery is removable and can be easily replaced. As soon as the battery has reached the end of life or just runs out of power, a replacement battery can be inserted into the battery compartment for powering the aerosol-generating device. Therefore, the use of the aerosol-generating device is no longer bound to the lifetime or limited by the capacity of a single battery. The simple exchangeability of the battery allows intensive smokers to continuously use the aerosol-generating article in combination with several exchangeable batteries even in case there is no battery charging opportunity for a long time, e.g. during festivals, outdoor activities and the like.

Preferred examples and embodiments are subject of the dependent claims. Preferred features are disclosed below.

### General Aspects of the Aerosol-Generating Device

The aerosol-generating device may be a heater stick.

The aerosol-generating device may in tubular or substantially tubular form.

The aerosol-generating device may be a handheld device.

The aerosol-generating device may have the appearance and/or handling of a cigarette or cigar.

The main axis/main extension direction of the aerosol-generating device, namely the axis/direction in which the aerosol-generating device has its greatest length, may be in a longitudinal axis/direction. A transversal axis/direction may be perpendicular to the longitudinal axis/direction. A circumferential direction may be defined around the longitudinal axis/direction. In an upright orientation of the aerosol-generating device, the longitudinal axis/direction may be a height axis/direction and the transversal axis/direction may be a horizontal axis/direction. Any indications in the following regarding “upper”, “top”, “lower” and “bottom” are with respect to the longitudinal axis/direction being the height axis/direction.

### Design and Shape of the Housing

The housing may have an opening for removing the battery from the battery compartment and inserting the same or another battery into the battery compartment. The opening may have a closure that can be arranged selectively arranged in any one of at least two different states, including a closed state, in which the battery is locked in the battery compartment or housing, and an open state, in which the battery can be removed from or inserted into the battery compartment or housing. The opening may have a circular shape with a diameter slightly larger than the diameter of the battery or battery compartment. The opening may be configured such that the battery or battery compartment must be inserted into and/or removed from the housing along the longitudinal axis of the battery.

The housing may comprise an elongate body extending along a linear axis forming its main axis.

The housing may have a top end and a bottom end.

The aerosol-generating article-receiving cavity may be concentrically arranged with a main axis of the housing.

The housing may have one of a tubular shape, a cylindrical shape, a tapered shape, or a partially cylindrical and partially tapered shape.

The housing may have a polygonal, oval or elliptic cross-sectional area.

The housing and the power supply unit may be configured such that the housing can accommodate the power supply unit in different orientations, in particular in a first orientation, in which the power supply unit is inversely oriented with respect to a second orientation.

The housing may comprise an opening for inserting the aerosol-generating article into the aerosol-generating article-receiving cavity.

### Power Supply Unit

The power supply unit may be sealed within the housing.

The power supply unit may comprise a controller for controlling power supply from the battery during operation of the aerosol-generating device.

The power supply unit may be removably accommodated in the housing.

The power supply unit may comprise an elongate body defining a main axis.

The power supply unit may be concentrically arranged with respect to the main axis of the housing in the receptacle.

The power supply unit may be configured such that it can be inserted into the receptacle in at least two different/inverted/flipped orientations.

The power supply unit may comprise electrical terminals of different polarity (plus and minus) at each of two opposite ends thereof.

The electrical terminals may be arranged in an identical pattern at each of two opposite ends thereof.

The electrical terminals may be symmetrically arranged with respect to each other at each of the opposite ends of the housing (“plus” symmetrical to “plus” and “minus” symmetrical to “minus”).

The power supply unit may comprise an electric circuity that connects the electrical terminals in parallel to the battery.

The electrical terminals and the poles of the battery of the same polarity may be electrically connected to each other.

The power supply unit may comprise male electrical terminals in form of interconnection electrodes or female electrodes in form of concentric rings.

### Reversibly Attachable Housing Portions

The housing may comprise two reversibly attachable housing portions, configured to be selectively arranged in any one of at least two different states, including an attached state, in which the housing portions are attached to each other, and a detached state, in which the housing portions are detached from each other. This embodiment allows easy replacement of the battery, or, if required, easy replacement of the battery compartment or even the entire power supply unit.

The housing portions may be designed for multiple use.

The housing may be separated into the two housing portions in a lateral direction.

A partition line or plane between the two housing portions may extend orthogonal to a longitudinal axis of the housing.

The housing may have an elongate shape defining a main axis of the housing.

Some or all outer surfaces of the first and second housing portions may be flush with each other in the attached state of the housing portions.

Some or all edges and/or corners of the mating surfaces of the first and second housing portions may be aligned with each other in the attached state of the housing portions.

The housing portions together may define a receptacle for accommodating the battery compartment or power supply unit.

The housing portions may lock the battery or battery compartment or power supply unit within the receptacle in the attached state.

The battery or battery compartment or power supply unit may be only removable from and reinsertable into the receptacle in the detached state of the housing portions.

One of the housing portions, in particular the housing portion comprising the aerosol-generating article-receiving cavity, may comprise the major part of the volume of the receptacle.

One of the housing portions may be a ring comprising an opening for accessing the aerosol-generating article-receiving cavity in the attached state of the housing portions.

One of the housing portions may be a closed end cap configured to close a receptacle for accommodating the battery compartment or power supply unit that is formed in the other housing portion in the attached state.

The state of rotation between the first and second housing portion may be not visible regardless of the amount of threadable tightening.

At least one of the housing portions may taper from its proximal/attachment end to its distal end at the outside and/or inside thereof.

At least a part of the battery compartment or power supply unit may be concentrically arranged within a housing portion that has a tapered shape.

A separation line between the housing portions may be at the end of the taper.

The housing portions may be configured to be attached to each other at their proximal ends.

The housing portions may have the same outer diameter at least at their proximal and/or distal ends so to provide a contiguous transition between the housing portions in the attached state of the housing.

The housing portion comprising the aerosol-generating article-receiving cavity may comprise a female thread and the other housing portion may comprise a male thread, or vice versa.

The housing portions may be configured to be attached to each other by a bayonet joint or a threaded joint.

The housing portions may comprise mutually engaging threads.

### Locking Mechanism for Locking Housing Portions in the Attached State

The aerosol-generating device may comprise a locking mechanism configured for removably locking the housing portions in the attached state. Such locking mechanism may prevent inadvertent detachment of the housing portions.

The aerosol-generating device may comprise an actuator configured to lock/unlock the locking mechanism upon actuation.

### Torque-Engaging Structure

The housing may comprise at least one torque-engaging structure configured to engage with a matching torque tool for applying torque to the housing. Such torque-engaging structure simplifies application of a predetermined quantity of torque to the housing, e.g. for opening the housing in context with battery replacement.

The torque-engaging structure may be provided at the bottom end of the housing, opposite to the top end of the housing comprising the aerosol-generating article-receiving cavity.

The torque-engaging structure may be provided on at least one of the two housing portions.

The torque-engaging structure may comprise a female torque-engaging element, for example, but not limited to a hex structure, torx structure, philips structure.

The female torque-engaging element may comprise a recessed flower-shaped pattern.

The female torque-engaging element may have a six-point flower-shaped pattern.

The female torque-engaging element may have holes that are equally spaced around a longitudinal axis of the aerosol-generating device.

The female torque-engaging element may comprise recesses or cavities.

The torque engaging structure may be concentrically arranged with respect to a longitudinal axis of the housing.

The torque-engaging structure may be arranged around an electric terminal.

The torque-engaging structure may be configured to apply torque around a longitudinal axis of the housing.

### External Electrical/Mechanical Interface of the Housing

The housing may comprise an external electrical and/or mechanical interface that is electrically and/or mechanically connectable to an external device, in particular a charging device or a docking station. Such an external interface may be particularly useful to enable simple and safe charging of the battery without removing the battery from the battery compartment or housing.

The external interface may be arranged at an end of the housing in the longitudinal direction, in particular a bottom end.

The external interface may comprise external electrical terminals of different polarity.

The external electrical terminals may be concentrically arranged with respect to a longitudinal axis of the housing.

A smallest radial extension of the female torque-engaging element from a longitudinal axis of the housing may be bigger than a largest radial extension of the electrical terminals.

A smallest radial extension of the female torque-engaging element from the central axis may be same as the smallest radial extension of the electrical terminals.

The external electrical terminals may have an annular shape.

The external electrical terminals may be formed as concentric rings.

The external electrical interface may comprise an isolation element located between the external electrical terminals.

The external interface may comprise an attachment mechanism configured to mechanically and/or magnetically attach to an external device.

The attachment mechanism may comprise a magnetic element.

The attachment mechanism may be concentrically arranged with respect to the longitudinal axis.

The attachment mechanism may be surrounded by the external electrical terminals.

### Internal Electrical/Mechanical Interface of the Housing

The housing may comprise an internal electrical and/or mechanical interface that is electrically and/or mechanically connectable to the battery compartment or power supply unit. Such an internal interface may be particularly useful to allow easy removal and installation of the battery compartment or power supply unit or other unit from/into the housing.

The internal interface comprises electrical terminals (of different polarity) which may be electrically connectable to electrical terminals (of different polarity) of the battery compartment or power supply unit.

Each of the two housing portions may comprise electrical terminals of different polarity.

The electrical terminals of different polarity may be provided in a radial distance to each other with respect to a central axis of the housing.

The internal interface may comprise male terminals, which are electrically and/or mechanically connectable to female terminals of the battery compartment or power supply unit.

The internal interface may comprise female terminals, which are electrically and/or mechanically connectable to male terminals of the battery compartment or power supply unit.

At least one of the male terminals may be at least one a pin, a tab, an elastic pin or tab including at least one of a spring-loaded pin or tab, a pogo pin, or a pin or tab made of an elastic material.

At least one of the female terminals may be a recess, in particular an annular recess.

The internal electrical terminals may be formed as concentric rings.

The battery compartment or power supply unit may be electrically connectable to the internal electrical interface of the housing.

### Power-Consuming Unit

The device may comprise a power-consuming unit, configured to consume power during operation of the aerosol-generating device, in particular for generating an aerosol.

The power-consuming unit may comprise a heater for heating an aerosol-generating article, such as an induction coil or electrical resistance heating means.

The power-consuming unit may be removably accommodated in the housing.

The power-consuming unit and the power supply unit may be removably accommodated within the same receptacle of the housing.

The power-consuming unit and the power supply unit may be removable though the same opening of the housing.

The power-consuming unit and the power supply unit may be combined to be removable from and/or insertable into the housing as a single unit.

The power-consuming unit and the power supply unit may be accommodated in the housing such that the power-consuming unit must be removed prior to removal of the power supply unit.

The power-consuming unit and the power supply unit may be accommodated in the housing such that the power supply unit must be accommodated (installed) first in the housing before the power supply unit can be accommodated (installed).

### Aerosol-Generating-Compartment

The device, in particular the power-consuming unit, may comprise an aerosol-generating compartment that is accommodated within the housing and comprises the aerosol-generating article-receiving cavity.

The aerosol-generating compartment may be removably accommodated within the housing.

The aerosol-generating device may comprise a spacer for spacing the aerosol-generating compartment from a housing wall.

The spacer may form a gap between the aerosol-generating compartment and the housing wall.

One of the housing portions may form a removable cap for securing the aerosol-generating compartment within the housing.

The cap may cover the gap between the aerosol-generating compartment and the housing wall.

The cap may be formed as a ring element.

### Identification Item

The power-supply unit may comprise an identification item. The device may comprise an identification unit for identifying the power-supply unit by means of the identification item.

The identification item may include a secret key/an authentication key. The authentication key may be one that is shared among many power supply units, or may be unique to each power supply unit.

The identification item may include a secret key/authentication key, allowing unique identification of the power-supply unit equipped with the unique identification item.

The identification unit may comprise a communication interface enabling communication between the housing and the power-supply unit for identification.

The communication interface may be at least one of a wireless communication interface or a contact-based interface.

The identification item may be permanently embedded in the power supply unit, and may be such that the secret key cannot be read from outside the unit, and is concealed within the power supply unit, and authentication can be done by the use of a session key that is generated from the secret key of the identification item.

The identification item may be at least one of an embedded-SIM (eSIM) or integrated SIM (ISIM).

The device may be configured to admit power supply from the power-supply unit for aerosol generation upon successful identification of the power-supply unit.

### Aerosol-Generating System

According to a second aspect of the invention, there is provided an aerosol-generating system comprising the aerosol-generating device according to any of the preceding embodiments/examples and a charging device configured to charge the power supply unit of the aerosol-generating device.

The charging device may be removably coupleable to the aerosol-generating device.

The charging device may comprise an electrical and/or mechanical interface that is electrically and/or mechanically connectable to the external interface of the aerosol-generating device, in particular for charging the battery of the aerosol-generating device.

The charging device may comprise a cavity for at least partially receiving the aerosol-generating device.

### Battery Replacement Method

According to a third aspect of the invention, there is provided a method for replacing the battery of an aerosol-generating device according to any of the preceding embodiments/examples, comprising the following steps: opening the housing, removing the battery from the battery compartment of the power supply unit, inserting a replacement battery into the battery compartment and closing the housing.

The housing may be opened by arranging the housing portions in the detached state.

The housing may be closed by arranging the housing portions in the attached state.

For transferring the housing between the attached state and the detached state, the housing portions may be rotated relative to each other to engage/disengage the threaded joint or bayonet joint.

For rotating housing portions relative to each other a torque may be applied to each of the housing portions in different directions, preferably via a tool engaging with a torque engaging structure provided on one of the housing portions, wherein the other housing portion is held by a user to produce a counter-torque.

### Use of Attachable Housing Portions for Forming a Housing

A fourth aspect of the invention relates to the use of two removably attachable housing portions for forming a housing of an aerosol-generating device that comprises a power supply unit with a battery compartment for removably holding a battery.

### LIST OF EXAMPLES

The invention is defined in the appended claims. However, below there is provided a non-exhaustive list of non-limiting examples. Any one or more of the features of these examples may be combined with any one or more features of another example, embodiment, or aspect described herein.
Example Ex1: An aerosol-generating device comprising: a power supply unit, configured to supply power for operation of the aerosol-generating device to generate an aerosol, wherein the power supply unit comprises a battery compartment for removably holding a battery, and a housing comprising the power supply unit as well as an aerosol-generating article-receiving cavity for removably receiving an aerosol-generating article.
Example Ex2: An aerosol-generating device according to the preceding Example, wherein the aerosol-generating device may be a heater stick, wherein the heater stick may be in tubular or substantially tubular form.
Example Ex3: An aerosol-generating device according to any one of the preceding Examples, wherein the power supply unit is sealed within the housing.
Example Ex4: An aerosol-generating device according to any one of the preceding Examples, wherein the aerosol-generating device is a handheld device
Example Ex5: An aerosol-generating device according to any one of the preceding Examples, wherein the housing comprises an elongate body extending along a linear axis forming the main axis.
Example Ex6: An aerosol-generating device according to any one of the preceding Examples, wherein the housing has a top end and a bottom end.
Example Ex7: An aerosol-generating device according to any one of the preceding Examples, wherein the cavity is concentrically arranged with a main axis of the housing.
Example Ex8: An aerosol-generating device according to any one of the preceding Examples, wherein the housing comprises two reversibly attachable housing portions, configured to be selectively arranged in any one of at least two different states, including an attached state, in which the housing portions are attached to each other, and a detached state, in which the housing portions are detached from each other.
Example Ex9: An aerosol-generating device according to Example Ex8, wherein the housing portions together define a receptacle for accommodating the power supply unit.
Example Ex10: An aerosol-generating device according to Example Ex9, wherein the power supply unit is locked within the receptacle in the attached state of the housing
Example Ex11: An aerosol-generating device according to any one of the Examples Ex8 to Ex10, wherein the power supply unit is only removable from and reinsertable into the housing upon separation of the housing portions.
Example Ex12: An aerosol-generating device according to any one of the Examples Ex9 to Ex11, wherein one of the housing portions, in particular the housing portion comprising the cavity, comprises the major part of the volume of the receptacle.
Example Ex13: An aerosol-generating device according to any one of the Examples Ex8 to Ex12, wherein one of the housing portions is a ring comprising an opening for accessing the cavity in the attached state of the housing.
Example Ex14: An aerosol-generating device according to any one of the Examples Ex8 to Ex13, wherein one of the housing portions is a closed end cap configured to close the receptacle in the attached state of the housing.
Example Ex15: An aerosol-generating device according to any one of the Examples Ex8 to Ex14, wherein at least one of the housing portions has one of a cylindrical shape, a tapered shape, or a partially cylindrical and partially tapered shape.
Example Ex16: An aerosol-generating device according to any one of the Examples Ex8 to Ex15, wherein the housing can be other shapes, like with a polygon-shaped cross-sectional area, oval or elliptic cross-sectional area, while the body is longitudinal and extending along a main axis.
Example Ex17: An aerosol-generating device according to any one of the Examples Ex8 to Ex16, wherein the bottom cap of the second housing portion is tapered relative to the main cylindrically shaped body of the first housing portion, and/or the power supply unit lies at least partially within the second housing portion that has a tapered shape, and/or the separation line between the first and second housing is at the end of the taper, thereby making it less visible.
Example Ex18: An aerosol-generating device according to any one of the Examples Ex8 to Ex16, wherein the housing portions are configured to be attached to each other at their proximal ends.
Example Ex19: An aerosol-generating device according to any one of the Examples Ex8 to Ex18, wherein the housing portions have the same outer diameter at least at their distal ends (so to provide a contiguous transition between the housing portions in the attached state of the housing).
Example Ex20: An aerosol-generating device according to any one of the Examples Ex8 to Ex19, wherein the housing portion comprising the aerosol-generating article-receiving cavity comprises a female thread and the other housing portion comprises a male thread, or vice versa.
Example Ex21: An aerosol-generating device according to any one of the Examples Ex8 to Ex20, wherein the housing portions are configured to be attached to each other by a bayonet joint or a threaded joint.
Example Ex22: An aerosol-generating device according to Example Ex21, wherein the housing portions comprise mutually engaging threads.
Example Ex23: An aerosol-generating device according to any one of the Examples Ex8 to Ex22, wherein the aerosol-generating device comprises a locking mechanism configured for removably locking the housing portions.
Example Ex24: An aerosol-generating device according to Example Ex23, wherein the aerosol-generating device comprises an actuator configured for locking/unlocking the locking mechanism upon actuation.
Example Ex25: An aerosol-generating device according to any one of the preceding Examples, wherein the housing comprises an inner electrical interface for electrically connecting to the battery compartment or power supply unit.
Example Ex26: An aerosol-generating device according to any one of the preceding Examples, wherein housing and the battery compartment or power supply unit are configured such that the housing can accommodate the battery compartment or power supply unit in different orientations, in particular in a first orientation, in which the battery compartment or power supply unit is inversely oriented with respect to a second orientation.
Example Ex27: An aerosol-generating device according to any one of the Examples Ex8 to Ex26, wherein the housing is separated in lateral direction into the two housing portions, wherein a separation line or plane between the two housing portions extends in a lateral direction orthogonal to a longitudinal axis.
Example Ex28: An aerosol-generating device according to any one of the preceding Examples, wherein the housing has an elongate shape defining a main axis of the housing,
Example Ex29: An aerosol-generating device according to any one of the preceding Examples, wherein the housing is portioned into the two housing portions in a direction orthogonal to a main axis of the housing, in particular in the longitudinal direction.
Example Ex30: An aerosol-generating device according to the preceding Example, wherein a portioning line between the two housing portions extends orthogonal to the main axis, in particular orthogonal to the longitudinal axis.
Example Ex31: An aerosol-generating device according to Example Ex30, wherein the portioning line between the two housing portions extends from one side to the other side of the housing.
Example Ex32: An aerosol-generating device according to any one of the preceding Examples, wherein the housing comprises at least one torque engaging structure configured to engage with a matching torque tool for applying torque to the housing.
Example Ex33: An aerosol-generating device according to Example Ex32, wherein the torque engaging structure is provided at the bottom end of the housing.
Example Ex34: An aerosol-generating device according to any one of the Examples Ex32 to Ex33, wherein the torque-engaging structure is provided on at least one of the two housing portions.
Example Ex35: An aerosol-generating device according to any one of the Examples Ex32 to Ex34, wherein the torque-engaging structure comprises a female torque-engaging element.
Example Ex36: An aerosol-generating device according to Example Ex35, wherein the female torque-engaging element comprises a recessed flower-shaped pattern.
Example Ex37: An aerosol-generating device according to any one of the Examples Ex35 to Ex36, wherein the female torque-engaging element a six-point flower-shaped pattern, or holes that are equally spaced around a longitudinal axis of the aerosol-generating device.
Example Ex38: An aerosol-generating device according to any one of the Examples Ex32 to Ex37, wherein the torque-engaging structure is concentrically arranged with respect to a longitudinal axis of the housing and/or wherein the torque-engaging structure includes recesses or cavities that are arranged around an electric terminal that is arranged on a bottom surface of the housing.
Example Ex39: An aerosol-generating device according to any one of the preceding Examples, wherein the housing comprises an external electrical and/or mechanical interface that is electrically and/or mechanically connectable to an external device, in particular a charging device or a docking station.
Example Ex40: An aerosol-generating device according to Example Ex39, wherein the external interface is arranged at an end of the housing in the longitudinal direction, in particular a bottom end.
Example Ex41: An aerosol-generating device according to Example Ex39 or Ex40, wherein the external interface comprises external electrical terminals of different polarity, which are concentrically arranged with respect to a longitudinal axis of the housing.
Example Ex42: An aerosol-generating device according to the Example Ex41, wherein a smallest radial extension of the female torque engaging element from a longitudinal axis of the housing is bigger than a largest radial extension of the electrical terminals.
Example Ex43: An aerosol-generating device according to any one of the Examples Ex41 to Ex42, wherein a smallest radial extension of the female torque-engaging element from the central axis is same as the smallest radial extension of the electrical terminals.
Example Ex44: An aerosol-generating device according to any one of the Examples Ex41 to Ex43, wherein the external electrical terminals have an annular shape.
Example Ex45: An aerosol-generating device according to any one of the Examples Ex41 to Ex44, wherein the external electrical interface comprises an isolation element located between the external electrical terminals.
Example Ex46: An aerosol-generating device according to any one of the Examples Ex39 to Ex45, wherein the external interface comprises an attachment mechanism configured to mechanically and/or magnetically attach to an external device.
Example Ex47: An aerosol-generating device according to Example Ex46, wherein the magnetically attachment mechanism comprises a magnetic element.
Example Ex48: An aerosol-generating device according to Example Ex47, where the magnetic element is concentrically arranged with respect to the longitudinal axis.
Example Ex49: An aerosol-generating device according to any one of the Examples Ex47 to Ex48, where the magnetic element is surrounded by the external electrical terminals.
Example Ex50: An aerosol-generating device according to any one of the preceding Examples, wherein the housing comprises an internal electrical and/or mechanical interface that is electrically and/or mechanically connectable to battery compartment or the power supply unit.
Example Ex51: An aerosol-generating device according to any one of the preceding Examples, wherein the device further comprises a power-consuming unit, configured to consume power during operation of the aerosol-generating device, in particular for generating an aerosol.
Example Ex52: An aerosol-generating device according to Example Ex51, wherein the power-consuming unit comprises a heater for heating an aerosol-generating article, such as an induction coil or electrical resistance heating means.
Example Ex53: An aerosol-generating device according to any one of the Examples Ex51 to Ex52, wherein the power consuming unit and the power supply unit are removably accommodated within the same receptacle of the housing.
Example Ex54: An aerosol-generating device according to any one of the Examples Ex51 to Ex53, wherein the power-consuming unit and the power supply unit are removable though the same opening of the housing.
Example Ex55: An aerosol-generating device according to any one of the Examples Ex51 to Ex54, wherein the power consuming unit and the power supply unit are accommodated in the housing such that the power consuming unit must be removed first from the housing before the power supply unit can be removed.
Example Ex56: An aerosol-generating device according to any one of the Examples Ex51 to Ex55, wherein the power consuming unit and the power supply unit are accommodated in the housing such that the power supply unit must be accommodated (installed) first in the housing before the power supply unit can be accommodated (installed).
Example Ex57: An aerosol-generating device according to Example Ex50, wherein the internal interface comprises electrical terminals (of different polarity), which are electrically connectable to interconnection electrodes (of different polarity) of the battery compartment or power supply unit,
Example Ex58: An aerosol-generating device according to Example Ex57, wherein each of the two housing portions comprises electrical terminals of different polarity.
Example Ex59: An aerosol-generating device according to any one of the Examples Ex50 or Ex57 to Ex58, wherein the electrical terminals of different polarity are provided in a radial distance to each other with respect to a central axis of the housing.
Example Ex60: An aerosol-generating device according to any one of the Examples Ex50 or Ex57 to Ex59, wherein the internal interface comprises male terminals which are electrically and/or mechanically connectable to female terminals of the battery compartment or power supply unit, or wherein the internal interface comprises female electrical terminals which are electrically and/or mechanically connectable to male terminals of the battery compartment or power supply unit.
Example Ex61: An aerosol-generating device according to Example Ex60, wherein at least one of the male terminals is at least one a pin, a tab, an elastic pin or tab including at least one of a spring-loaded pin or tab, a pogo pin, or a pin or tab made of an elastic material.
Example Ex62: An aerosol-generating device according to any one of the Examples Ex60 to Ex61, wherein at least one of the female terminals is a recess.
Example Ex63: An aerosol-generating device according to any one of the preceding Examples, wherein the battery compartment or power supply unit is removably accommodated in the housing.
Example Ex64: An aerosol-generating device according to Example Ex63, wherein the battery compartment is electrically connectable to the internal electrical interface of the housing.
Example Ex65: An aerosol-generating device according to any one of the Examples Ex63 to Ex64, wherein the battery compartment comprises an elongate body defining a main axis.
Example Ex66: An aerosol-generating device according to any one of the Examples Ex63 to Ex65, wherein the battery compartment is concentrically arranged with respect to the main axis of the housing.
Example Ex67: An aerosol-generating device according to any one of the Examples Ex63 to Ex66, wherein the battery compartment is configured such that it can be inserted into the housing in at least two different/inverted/flipped orientations.
Example Ex68: An aerosol-generating device according to any one of the Examples Ex63 to Ex67, wherein the battery compartment comprises interconnection electrodes of different polarity (plus and minus) at each of two opposite ends thereof.
Example Ex69: An aerosol-generating device according to Example Ex68, wherein the interconnection electrodes are arranged in an identical pattern at each of two opposite ends of the battery compartment.
Example Ex70: An aerosol-generating device according to any one of the Examples Ex68 to Ex69, wherein the interconnection electrodes are symmetrically arranged with respect to the battery compartment at each of the opposite ends of the housing (“plus” symmetrical to “plus” and “minus” symmetrical to “minus”).
Example Ex71: An aerosol-generating device according to any one of the Examples Ex68 to Ex70, wherein the battery compartment comprises an electric circuity that connects the interconnection electrodes parallel to the battery.
Example Ex72: An aerosol-generating device according to Examples Ex68 to Ex71, wherein the interconnection electrodes and the poles of the battery of the same polarity are electrically connected to each other.
Example Ex73: An aerosol-generating device according to Examples Ex68 to Ex72, wherein the interconnection electrodes are concentric rings.
Example Ex74: An aerosol-generating device according to any one of the preceding Examples, wherein the device comprises an aerosol-generating compartment that is accommodated within the housing and comprises the aerosol-generating-article-receiving cavity.
Example Ex75: An aerosol-generating device according to Example Ex74, wherein the aerosol-generating compartment is removably accommodated within the housing.
Example Ex76: An aerosol-generating device according to Example Ex74 or Ex75, wherein the aerosol-generating device comprises a spacer for spacing the aerosol-generating-compartment from a housing outer wall.
Example Ex77: An aerosol-generating device according to Example Ex76, wherein the spacer forms a gap between the aerosol-generating compartment and the housing outer wall.
Example Ex78: An aerosol-generating device according to any one of the preceding Examples, wherein the housing comprises an opening for inserting the aerosol-generating article into the aerosol-generating article-receiving cavity.
Example Ex79: An aerosol-generating device according to Example Ex78, wherein one of the housing portions comprises the opening.
Example Ex80: An aerosol-generating device according to any one of the Examples Ex74 to Ex79, wherein one of the housing portions forms a removable cap for securing the aerosol-generating-compartment within the housing.
Example Ex81: An aerosol-generating device according to Example Ex80, wherein the cap covers the gap between the aerosol-generating compartment and the housing outer wall.
Example Ex82: An aerosol-generating device according to any one of the Examples Ex80 to Ex81, wherein the cap is formed as a ring element.
Example Ex83: An aerosol-generating device according to any one of the preceding Examples, wherein the power-supply unit comprises an identification item, wherein the device comprises an identification unit for identifying the power-supply unit by means of the identification item.
Example Ex84: An aerosol-generating device according to Example Ex83, wherein the identification item includes a secret key, preferably unique secret key, allowing (unique) identification of the power-supply unit equipped with the unique identification item.
Example Ex85: An aerosol-generating device according to any one of the Examples Ex83 to Ex84, wherein the identification unit comprises a communication interface enabling communication between the housing and the power-supply unit for identification.
Example Ex86: An aerosol-generating device according to Example Ex85, wherein the communication interface is at least one of a wireless communication interface or a contact-based interface.
Example Ex87: An aerosol-generating device according to any one of the Examples Ex83 to Ex86, wherein the identification item is permanently embedded.
Example Ex88: An aerosol-generating device according to any one of the Examples Ex83 to Ex87, wherein the identification item is at least one of an embedded-SIM (eSIM) or integrated SIM (ISIM).
Example Ex89: An aerosol-generating device according to any one of the Examples Ex83 to Ex88, wherein the identification item comprises an authentication key.
Example Ex90: An aerosol-generating device according to any one of the Examples Ex83 to Ex89, wherein the device is configured to admit power supply from the power-supply unit for aerosol generation upon successful identification of the power-supply unit.
Example Ex91: An aerosol-generating system comprising the aerosol-generating device according to any of the preceding Examples and a charging device configured to charge the power supply unit of the aerosol-generating device.
Example Ex92: An aerosol-generating system according to Example Ex91, wherein the charging device is removably coupable to the aerosol-generating device.
Example Ex93: An aerosol-generating system according to any one of the Examples Ex91 or Ex92, wherein the charging devices comprise an electrical and/or mechanical interface that is electrically and/or mechanically connectable to the external interface of the aerosol-generating device, in particular for charging the power supply unit of the aerosol-generating device.
Example Ex94: An aerosol-generating system according to any one of the Examples Ex91 to Ex93, wherein the charging device comprises a cavity for at least partially receiving the aerosol-generating device.
Example Ex95: Method for replacing the battery of an aerosol-generating device according to any of the preceding claims, comprising the following steps:
Opening the housing.
Removing the battery from the battery compartment of the power supply unit.
Inserting a replacement battery into the battery compartment.
Closing the housing.
Example Ex96: Method according to Example Ex95, wherein the housing is opened by transferring the housing from the attached state into the detached state.
Example Ex97: Method according to any one of the Examples Ex95 to Ex96, wherein the housing is closed by transferring the housing from the detached state into the attached state.
Example Ex98: Method according to any one of the Examples Ex95 to Ex97, wherein for transferring the housing between the attached state and the detached state, the housing portions are rotated relative to each other to engage/disengage the threaded joint or bayonet joint.
Example Ex99: Method according to any one of the Examples Ex95 to Ex98, wherein for rotating housing portions relative to each other a torque is applied to each of the housing portions in different directions, preferably via a tool engaging with a torque engaging structure provided on one of the housing portions, wherein the other housing portion is held by a user to produce a counter-torque.
Example Ex100: Use of two removably attachable housing portions for forming a housing of an aerosol-generating device that comprises a power supply unit with a battery compartment for removably holding a battery.

The method according to Examples Ex95 to E98 may be performed with the device according to examples Ex1 to Ex90. The device according to examples E1 to Ex90 may be used according to example Ex100.

### Terms and Definitions

Some relevant terms as used herein are defined as follows:

### Power Supply Unit

The term “power supply unit” as used herein designates the very unit that is required to supply power to generate the aerosol, including e.g. electronics and/or a controller for starting and stopping the supply of power from the battery to a power-consuming unit.

### Battery Compartment

The term battery compartment as used herein designates a device, unit or assembly that is configured to removably hold the battery, and at the same time ensure that the battery is removably electrically interconnected to the aerosol generating device or system. It may serve as a battery housing within the housing of the aerosol-generating device, for example the exterior housing that can be held or grasped by a user. The battery compartment may also provide the electrical contacts for drawing power from the battery. The battery compartment may itself have electrical interfaces for supplying power from the battery to a controller. Preferably, the battery compartment is configured such that a user can manually and reversibly remove and insert the battery thereto, without the need for special tooling or a destructive process. For example, the battery compartment can be such that the battery can be removed and inserted without cutting electrical interconnections with a cutting tool, such as but not limited to a scissor, shear cutter, shears, wire cutter, saw. Also, the battery compartment can be such that no casing parts or enclosures need to be broken or otherwise irreversibly damaged, as can be found in electronic assemblies with batteries that cannot be readily removed by a user. Furthermore, the battery compartment can also be configured such that the removal of the battery is obvious to a user, similar to ones used in conventional electronic devices, without the need of engaging with hidden release features that require specific knowledge.

### FIGURES

Exemplary embodiments of the invention will now be further described with reference to the figures in which:

FIG. 1 shows an exploded perspective view of an aerosol-generating device according to a first embodiment of the invention, wherein the housing has a tubular shape and extends along a longitudinal main axis, wherein the first (lower) housing portion defines a tubular receptacle for removably receiving a removable internal unit, including the power supply unit with the battery compartment and the battery as well as a power consuming unit including an aerosol generating compartment, wherein the second (upper) housing portion is formed as a ring for securing the removable internal unit in the receptacle;

FIG. 2 shows an example of an internal electrical interface of the aerosol-generating device according to FIG. 1, wherein the internal electrical interface is provided on the top and bottom ends of a receptacle for receiving the battery compartment inside the housing and comprises female electrical terminals of different polarity in form of concentric rings;

FIG. 3 shows an example of an external electrical interface of the aerosol-generating device according to FIG. 1, wherein the external electrical interface is provided at a bottom end of the housing and comprises female electrical terminals of different polarity in form of concentric rings, wherein a flower-shaped torque-engaging structure is concentrically arranged outside of the outer one of the concentric rings of the female electrical terminals;

FIG. 4 shows an aerosol-generating system comprising the aerosol-generating device according to the first embodiment of the invention and a charging/docking station in a semi-attached state, wherein the aerosol-generating device is removably receivable within a longitudinal cavity of the charging/docking station, wherein, as shown in FIG. 4, the bottom end of the aerosol-generating device is located within the cavity, so as to provide a mechanical connection between the external interface of the aerosol-generating device and the respective electrical/mechanical interface of the charging device, about which the aerosol-generating device with its protruding top end can be pulled or pivoted either out of the cavity to be fully removed, or placed or pivoted into the cavity of the charging/docking station, so that the aerosol-generating device is fully received and clamped within the cavity about its longitudinal axis, and is electrically and mechanically connected to the charging/docking station in fully attached state (not shown);

FIG. 5 shows a schematic cross-sectional view of a removable battery compartment of the aerosol-generating device according to the first embodiment of the invention;

FIG. 6 shows an exploded perspective view of an aerosol-generating device according to a second embodiment of the invention, in which the housing comprises two reversibly attachable housing portions defining a tubular receptacle for removably receiving the battery compartment therebetween in an attached state of the housing portions, wherein the receptacle is partially formed in each of the housing portions;

FIG. 7 shows an exploded perspective view of an aerosol-generating device according to a third embodiment of the invention, in which the housing comprises two reversibly attachable housing portions defining a tubular receptacle for removably receiving the battery compartment therebetween in an attached state of the housing portions, wherein the upper housing portion comprises the tubular receptacle and the lower housing portion forms a bottom end cap for closing the receptacle in an attached state of the housing portions;

FIG. 8 shows an exploded schematic and sectional view of an aerosol-generating device according to a fourth embodiment of the invention, in which the housing comprises two reversibly attachable housing portions and in which the battery compartment is integrated into or attached to one of these housing portions, wherein the second (upper) housing portion comprises the aerosol-generating article-receiving cavity as well as the tubular receptacle for the battery compartment, wherein the first (lower) housing portion comprises the battery compartment and forms a bottom end cap for closing the receptacle in an attached state of the housing portions;

FIG. 9 shows an exploded schematic and sectional view of an aerosol-generating device according to a fifth embodiment of the invention, in which the housing comprises two reversibly attachable housing portions and in which the battery compartment is integrated into or attached to one of these housing portions, wherein the second (upper) housing portion comprises the aerosol-generating article-receiving cavity as well as the battery compartment and wherein the first (lower) housing portion comprises the tubular receptacle for the battery compartment;

FIG. 10 shows a schematic architecture of an identification unit for identifying a power-supply unit of the aerosol-generating device according to the invention.

### DESCRIPTION

The preferred embodiments of the present invention will be described herein with respect to the appended drawings.

The aerosol-generating device according to the preferred embodiment is a tubular-shaped or stick-shaped device that has an appearance and handling similar to a cigarette or cigar. The user may insert an aerosol-generating article such as a tobacco plug into the aerosol-generating article-receiving cavity at the top end of the housing and press a button for heating the aerosol-generating article for generating an aerosol. The power supply unit supplies the power for heating the aerosol-generating article received in the aerosol-generating article-receiving cavity upon user demand, so that the user can inhale the aerosol generated by the aerosol-generating device from the aerosol-generating article similar to the smoke of a cigarette or cigar. The power source for heating the aerosol-generating article is a battery that is removably received in a battery compartment of the power supply unit.

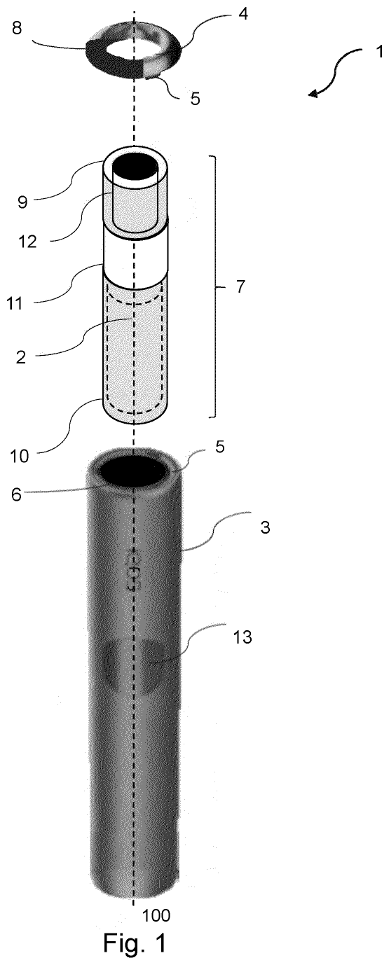

### First Embodiment (FIGS. 1-5)

The aerosol-generating device 1 as shown in FIG. 1 comprises housing portions 3, 4, with housing portion 3 being substantially tubular in shape, and housing portion 4 formed as a ring, which can be reversibly attached along a main axis 100 by a screw joint or bayonet joint 5, so as to enable quick and easy replacement of a battery 2. The first (lower) housing portion 3 has a cavity 6 for receiving a removable internal unit 7. The other, second (upper) housing portion defines a top end cap in the form of a ring 4 for securing the removable internal unit 7 within the first housing portion 3. The ring 4 may be provided with a torque engaging structure 8, in particular an opening with a torque pattern such as but not limited to a flower-shaped pattern, to engage with a torque tool (not shown) for removing the ring 4 from the first housing portion 3. Tubular housing portion 3 can be made as a unitary piece of material to form a tubular structure, for example a metal, for example but not limited to aluminum or an aluminum-alloy.

The removable internal unit 7 comprises a power-consuming unit 9 and the power supply unit with the battery compartment 10 as well as an electronics unit 11 arranged there between along the main axis 100. The power-consuming unit 9 and the battery compartment 10 may be mechanically attached to each other. The removable internal unit 7 may be removed as a single unit after removing the ring or second housing portion 4. The battery compartment 10 can removably hold the battery 2. The power-consuming unit 9 can comprise an aerosol-generating compartment in form of a tubular coil with a cylindrical aerosol-generating article-receiving cavity 12 for receiving an aerosol-generating article 12′, in particular a heater stick, for induction heating, thereby producing a consumable aerosol. Alternatively, the power consuming unit 9 can have different types of heaters, for example resistive heaters, or other types of heaters with the purpose of heating an aerosol/generating article that is removably placed inside cavity 12. The electronics unit 11 can comprise a controller and power electronics to draw electric power from the battery 2 upon user demand to the tubular coil for induction heating.

A main button 13 is provided on the first housing portion 3. The main button 13 is electrically connected to the electronic units 11 to control same upon activation. In particular, when the main button 13 is pushed, power is drawn from the battery 2 to the tubular coil for induction heating.

Battery 2 can be a standard or non-standard type battery that can be readily removed by the user from the battery compartment, once second housing portion or closing ring 4 is removed from the first tubular housing portion, and the removable internal unit 7 is pulled out from the first tubular housing portion 3.

An internal electric interface 14 is provided between the bottom face of the removable internal unit 7, in particular the battery compartment 10, and the internal bottom face of the first housing portion 3.

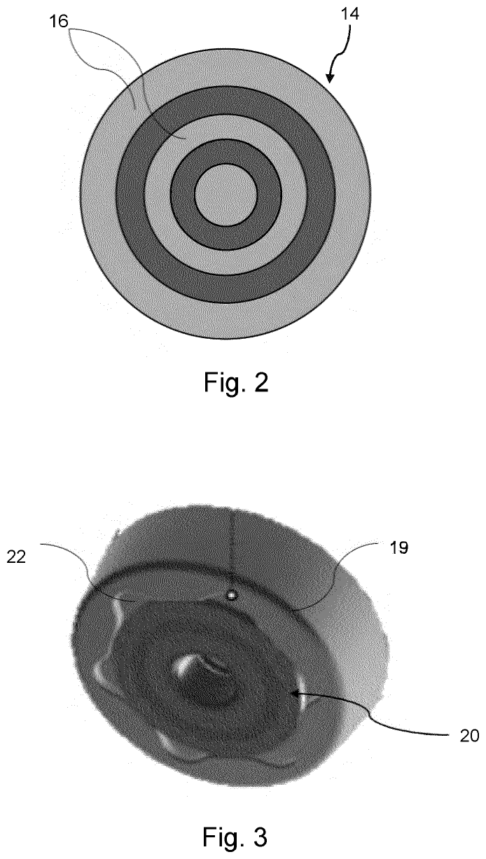

FIG. 2 shows said internal electrical interface 14 of the aerosol-generating device 1. As will be explained in more detail below, the internal electrical interface 14 enables orientation-independent electric interconnection between the battery compartment 10 and the first housing portion 3.

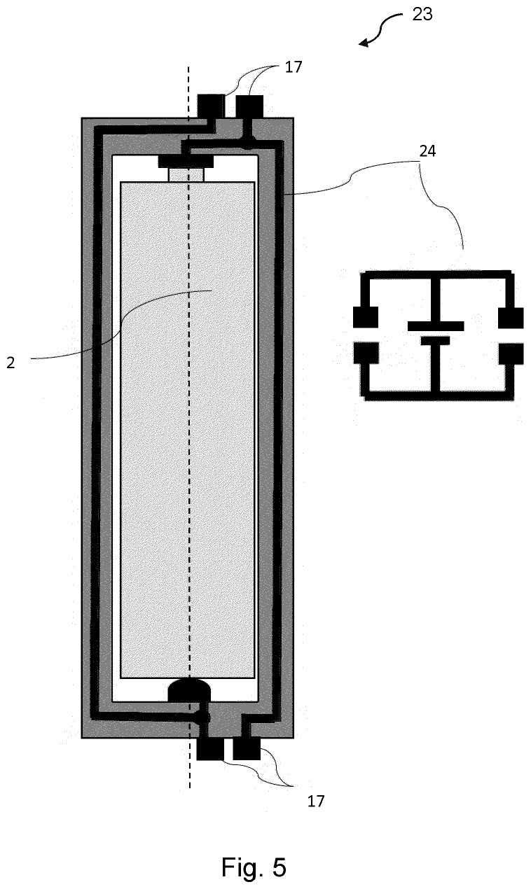

The internal electrical interface 14 can be provided e.g. on the top and bottom ends of the receptacle for receiving the battery compartment 10 inside the housing. The internal electrical interface comprises interconnection electrodes, in particular two concentric rings 16 of different polarity (plus and minus) around the main axis 100, separated by an isolator ring. The two concentric rings can electrically connected to two protruding elements, in particular spring-loaded pins 17 as depicted in FIG. 5, that are arranged to be offset by the main/center axis 100 by a radius that guarantees electric interconnection with both polarities irrespective of the angular orientation. In particular, the spring-loaded pins 17 are arranged with radius from the center axis 100 that is equal to the radius of the concentric rings 16 from the center axis. The spring-loaded pins 17 are loaded against the concentric rings 16 by an elastic element, thereby ensuring for an orientation-independent and a safe electrical connection even when the housing portions 3, 4 are not fully engaged.

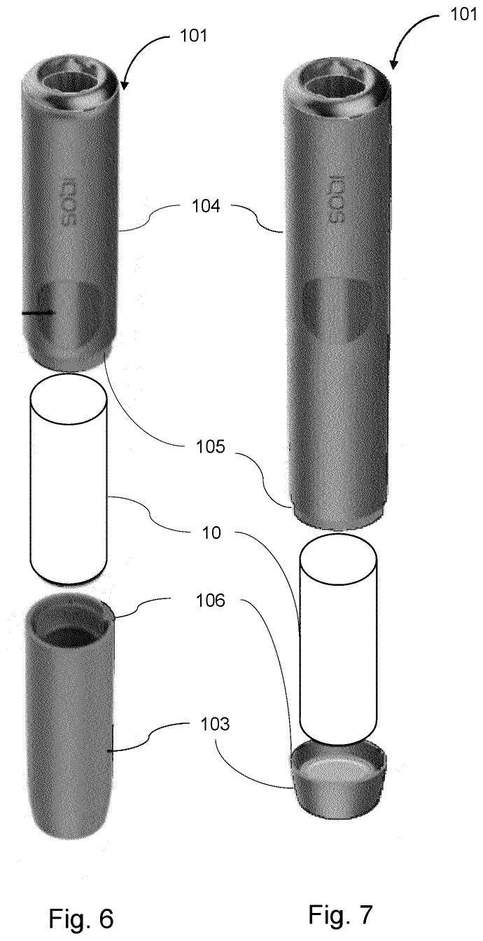

The internal interface 14 may also be used to connect the battery compartment 10 with one or both of an internal bottom face of the first housing portion 103, 203 and an internal top face of the second housing portion 104, 204 of the aerosol-generating devices 101, 201 depicted in FIGS. 6, 7 and 8, 9, respectively. Preferably, the internal interface 14 is on the internal bottom face and/or the internal top face of a respective housing portion (i.e., top end and/or bottom end of the receptacle).

In another variant, one ring and one protruding element (e.g., spring-loaded pin 17) with a different radius from the center axis 100 is provided on the battery compartment 10 to engage with the respective counterpart element on the housing side, again providing for an orientation independent electrical interconnection.

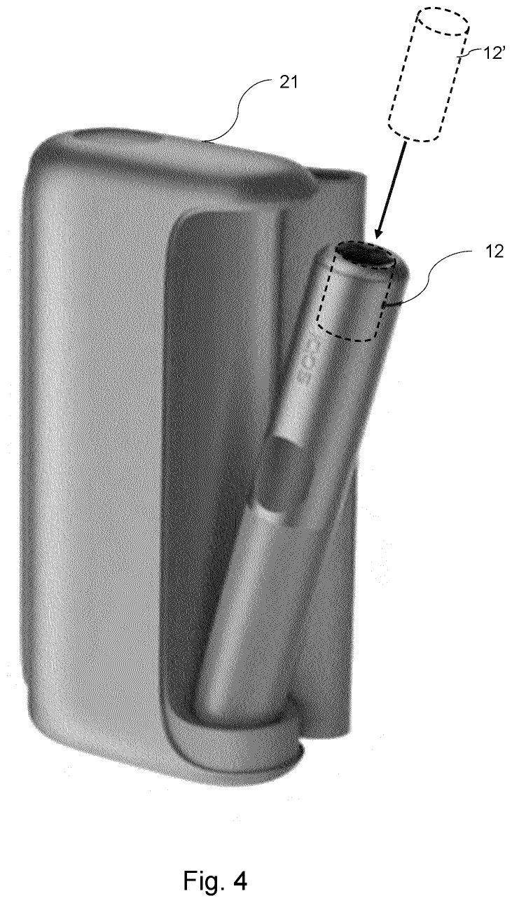

FIG. 3 is a bottom view of the housing and depicts a bottom end 19 of the first (lower) housing portion 3. The bottom end 19 comprises an external electrical interface 20 that is configured to engage with a charging device 21 as shown in FIG. 4 for charging of the battery, with two concentric electric terminals that guarantee for an electric interconnection to terminals of the charging device, irrespective of an angle of orientation around a main cylindrical axis of the tubular housing portion. The external electrical interface 20 has a similar structure as compared to the internal electrical interface 14 shown in FIG. 2. The external electrical interface 20 is surrounded by a torque engaging structure 22 to engage with a matching torque tool for applying torque to the first housing portion 3. The torque engaging structure 22 comprises a female torque-engaging element with a recessed flower-shaped pattern. Other torque engaging structure 22 can also be used, for example a hex or torx cavity in the center of the two concentrical rings 16. FIG. 5 is a schematic cross-sectional view of a battery compartment 23 that can be used in the aerosol-generating device 1 according to the present invention. Male electric terminals in form of spring-loaded pins 17 are provided on each of two opposite ends of the battery compartment 23. The male electric terminals 17 of different polarity (plus and minus) are provided in an identical pattern at each of two opposite ends of the battery compartment 23, such that the battery compartment 23 can be inserted into the housing in at least two different/inverted/flipped orientations. The male electric terminals 17 are configured to electrically connect to female electric terminals in form of concentric rings of the internal electric interface 14 (see FIG. 2) provided in respective positions in the interior of the housing, thereby also configured to provide for an electric interconnection between battery compartment 23 and the housing portions 103, 104, irrespective of an angular orientation around a main axis 100. An electric circuity 24 connects the spring-biased protruding electric terminals 17 of a respective side parallel to the battery 2. In other embodiments, interconnection electrodes in the form of two concentric rings 16 of different polarity (plus and minus) around the main axis 100 are used provided at the battery compartment 23 instead of the spring-biased protruding electric terminals 17. In such case, corresponding male electric terminals 17 would be provided in respective positions in the interior of the housing as the internal electric interface 14.

### Second Embodiment (FIG. 6)

FIG. 6 is an exploded perspective view of an aerosol-generating device 101 according to a second embodiment, wherein the first and second housing portions 103, 104 together define a cavity for accommodating the battery compartment 10. The second embodiment has the same features as the first embodiment except for the differences described herein.

The first (lower) housing portion 103 has a tubular form with a top-loading cavity for receiving a lower end or the entirety of the battery compartment 10. A lower part of the first housing portion 103 tapers towards its distal (lower) end. The second (upper) housing portion 104 has a tubular form with a bottom-loading cavity for receiving the upper end of the battery compartment 10, or just the upper surface of the battery compartment 10. The two housing portions 103, 104, are reversibly attachable along the main axis 100 by a threaded joint 105, 106. A male thread 105 is provided on the second (upper) housing portion 104. A mating female thread 106 is provided on first (lower) housing portion 104. However, the position of the male and female threads 105, 106 can also be reversed. The second (upper) housing portion accommodates the power-consuming unit 9 and the electronics unit 11 and comprises the aerosol-generating article-receiving cavity 12. Battery compartment 10 can be the one as shown in FIG. 5, and can therefore be placed into the cavity formed by housing portions 103, 104 in any way to provide for the electric interconnection.

### Third Embodiment (FIG. 7)

FIG. 7 is an exploded perspective view of an aerosol-generating device 101 according to a third embodiment, wherein the second (upper) housing portion 104 defines a bottom-loading cavity for accommodating the entirety or a upper part of the battery compartment 10 and wherein the first (lower) housing portion 103 defines a bottom end cap for closing the cavity in the attached state of the housing portions. The third embodiment has the same features as the second embodiment except for the differences described herein.

In FIG. 7, the first (lower) housing portion 103 entirely tapers towards its distal (lower) end. Internal electrical interfaces (not shown) like the one shown in FIG. 2 are provided inside the first (lower) housing portion 103 and the second (upper) housing portion 104, whereas an external electrical interface (not shown) like the one shown in FIG. 3 is provided at the exterior of the first (lower) housing portion 103.

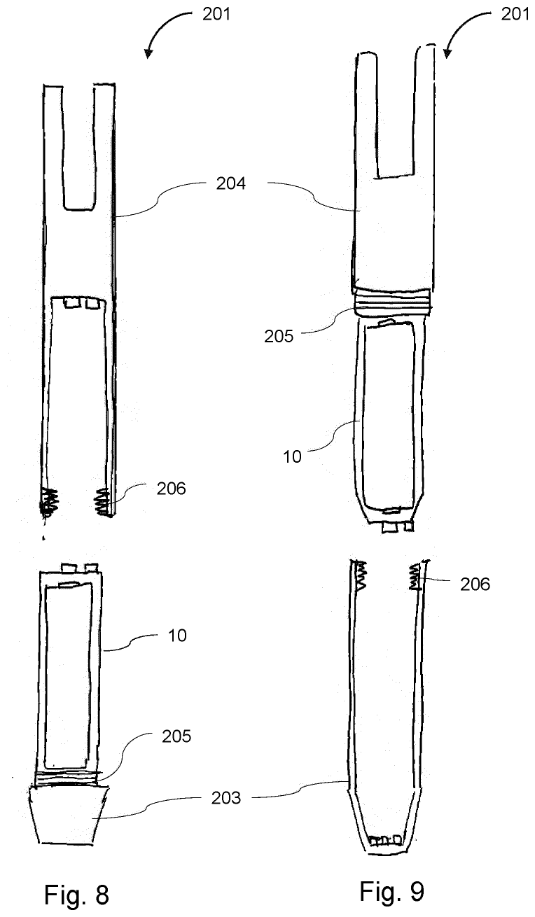

### Fourth Embodiment (FIG. 8)

FIG. 8 shows an aerosol-generating device 201 according to a fourth embodiment. In contrast to the aerosol-generating devices 101 depicted in FIGS. 6 and 7, the battery compartment 10 is fixed to or integrated into one of the first and second housing portions 203, 204, respectively. The forth embodiment has the same features as the third embodiment except for the differences described herein.

In FIG. 8, the battery compartment 10 is fixed to or integrated into the first (lower) housing portion 203, so as to protrude along the longitudinal main axis 100, enabling lateral removal and insertion of the battery from/into the battery compartment 10 as well as axial removal and insertion of the battery compartment 10 from/into the second (upper) housing portion 204. The second (upper) housing portion 204 has a tubular form with a bottom-loading cavity for receiving the battery compartment 10. The two housing portions 203, 204 are reversibly attached along the longitudinal main axis 100 by a threaded joint, wherein a male thread 205 can provided on the first (lower) housing portion and a mating female thread 206 can be provided on a distal (lower) end of the second (upper) housing portion 204, or vice versa. The first (lower) housing portion 103 entirely tapers from the separation line that remains visible in the attached state of the housing portions towards its distal (lower) end. An internal electric interface as shown in FIG. 2 is provided at the top end of the receptacle inside the second (upper) housing portion 204 to electrically connect to interconnection electrodes provided at the top end of the battery compartment 10 in the attached state of the housing portions 203, 204. As the bottom end of the battery compartment 10 is connected to the first (lower) housing portion 203, no interconnection electrodes are required there.

### Fifth Embodiment (FIG. 9)

FIG. 9 shows an aerosol-generating device 201 according to a fifth embodiment. The first embodiment has the same features as the second embodiment except for the differences described herein.

In FIG. 9, the battery compartment 10 is fixed to or integrated into the second (upper) housing portion 204. The second (upper) housing portion 204 has a tubular form. The battery compartment 10 protrudes from the second (upper) housing portion 204 along the longitudinal main axis 100, enabling lateral removal and insertion of the battery from/into the battery compartment 10 as well as axial removal and insertion of the battery compartment 10 from/into the first (lower) housing portion 204. The battery compartment 10 has a tapered bottom portion. A top-loading cavity for receiving the battery compartment 10 is provided in the first (lower) housing portion 103 and tapers towards its bottom end with a negative shape of the shape of the battery compartment 10, so as to simplify the concentric arrangement. The internal shape of the cavity and the external shape of the battery compartment 10 are mutually adapted to each other, so that the battery compartment 10 snugly fits into the cavity without rattling and wobbling in an attached state of the housing portions 203, 204. Moreover, the first housing portion 203 tapers at the outside thereof towards its distal (lower) end, so as to optically reduce the length and width of the housing, preferably down to a minimum length and width that is physically required to accommodate the battery compartment 10. The two housing portions 203, 204 are reversibly attachable along the main axis 100 by a threaded joint, wherein a female thread 206 is provided on the first (lower) housing portion 203 and a mating male thread 205 is provided on a distal end of the second (upper) housing portion 204. Preferably, the female thread 106 is provided on the housing portion comprising the receptacle for the battery compartment 10.

The surrounding torque engaging structure 22 surrounding the external electrical interface 20, in particular the recessed flower-shaped pattern as shown in FIG. 3, may also be provided on the external bottom end of the first housing portions 103, 203 of the aerosol-generating devices 101, 201 depicted in FIGS. 6, 7 and 8, 9, respectively, for threadable torque engagement of the two housing portions 103, 104 or 203, 204. An internal electric interface as shown in FIG. 2 is provided at the bottom end of the receptacle inside the first (lower) housing portion 203 to electrically connect to interconnection electrodes provided at the bottom end of the battery compartment 10 in the attached state of the housing portions 203, 204. As the top end of the battery compartment 10 is connected to the second (upper) housing portion 203, no interconnection electrodes are required there.

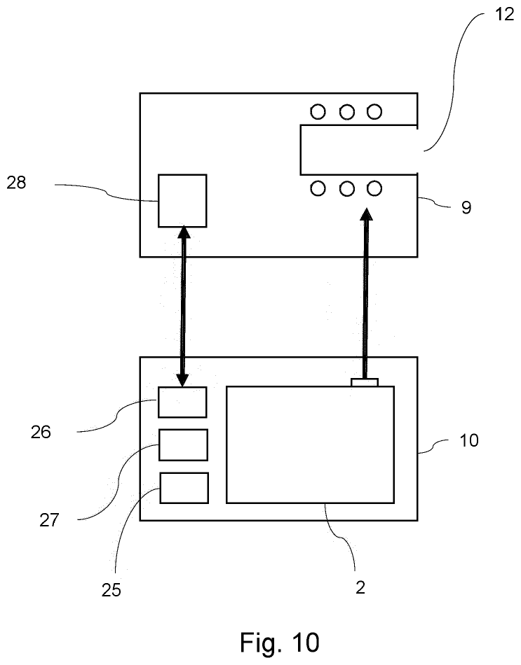

Identification Item FIG. 10 shows a schematic architecture of an identification unit for identifying the power-supply unit/battery compartment 10 by means of the identification item.

Every power-supply unit/battery compartment 10 can be equipped with an identification item, including a SIM 25 or device (subscriber identity module), for example a software-based eSIM card or SIM chip (micro-SIM or nano-SIMI), that can communicate via a data communication interface with the power consuming unit 9, for example once the power consuming unit 9 and the power-supply unit/battery compartment 10 are interconnected to each other. This can be done directly by communicating with the IO channel 26 of the SIM, or via an additional data processor 27 on the power-supply unit/battery compartment 10. The SIM 25 includes a secret and unique Ki encryption key that cannot be read from the outside of the SIM, that can be initially recorded by the manufacturer in a database for authenticating original power-supply unit/battery compartment 10s. Typically, the secret key Ki has a 128 bit value.

For example, each secret key Ki can be previously recorded in the database and can be uniquely associated with an authorized power-supply unit/battery compartment 10. Thereby, the power-supply unit/battery compartment 10 can be checked to see if it is an original or a copy, providing for a technical authenticity protection, to make sure that only original equipment is used, and to also make sure that batteries of a certain quality are used. Other data from the SIM 25 could also be used for authentication (other than the secret key Ki), for example but not limited to ICCID, IMSI, IMEI, MSISDN, and/or EID, however, the use of these numbers would provide for less security of the authentication. The SIM itself can also generate session keys from the secret Ki key, with the data processor that is internal to the SIM, so that the secret Ki key never leaves the electronics of the power-supply unit/battery compartment 10, more specifically the inner storage memory for the secret key of the SIM 25, and the power consuming unit 9, applying the same encryption/decryption algorithm to authenticate the power-supply unit/battery compartment 10, can authenticate the power-supply unit/battery compartment 10 with the one or more session keys.

In a simplified variant, to avoid managing many different secret keys for each and every power-supply unit/battery compartment 10, the power-supply unit/battery compartment 10 can be equipped with a digital circuit (not necessarily a SIM) having a secretly stored key among a certain limited number of secret keys, or just one secret key for all power-supply unit/battery compartment 10s, and the power consuming unit 9 can request authentication of the power-supply unit/battery compartment 10 based on the limited number of secret keys, or just the one secret key. For example, it is possible to use one and the same secret key for the power-supply unit/battery compartment 10 (or a limited number thereof), and then run an encryption algorithm to generate session keys for each algorithm. The power consuming unit 9 could have the same secret key stored therein (for example in a way that it cannot be read from the outside), and employ the same algorithm to authenticate the power-supply unit/battery compartment 10 with the session keys. This would allow to imitate the SIM 25 functionality with a limited complexity. In this respect, it is also possible that eSIM architecture is used, but using only using a limited number of keys, for example such that not every power-supply unit/battery compartment 10 has its unique and secret key Ki, but a certain limited number, or even just one secret key Ki. Such solution provides for less authentication security, but is much easier to manage, and could be sufficient for authenticating power-supply unit/battery compartment 10s for an aerosol generating system/device. Once the power consuming unit 9 has authenticated the power-supply unit/battery compartment 10, it would be possible to start or allow for aerosol formation by the power consuming unit 9, for example to enable heat generation by the power consuming unit 9. If the power-supply unit/battery compartment 10 could not be authenticated, error information could be generated, for example a visual, audible, or haptic signal or a combination thereof, and the power consuming unit 9 could be disabled.

It is technically also possible that the SIM 25 or equivalent circuit is integrated into the power consuming unit 9 or module, instead of the power-supply unit/battery compartment 10, and that the power-supply unit/battery compartment 10 authenticates the power consuming unit 9 before allowing the power consuming unit 9 to operate.

While the data communication can be done via a separate data communication channel between the power-consuming unit 9 and power-supply unit/battery compartment 10, it can also be done over the internal electrical interface 14, to thereby only have two power terminals and no specific data communication terminals or interconnections. It is also possible that the data communication for authentication is done via a wireless interface, for example Bluetooth or an RFID circuit.

In addition, the power-consuming unit 9 and the power supply unit/battery compartment 10 can be paired, for example with a pairing process that is for example performed by the power consuming unit 9 or electronics unit 11, thereby allowing to use unique keys for each power supply unit/battery compartment 10, without actually having to manage all the secret keys in a database. For example, upon first interconnection of a new or other original power supply unit/battery compartment 10 with the power consuming unit 9, the power consuming unit 9 or electronics unit 11 can request pairing, with a pairing algorithm. But it is also possible that the pairing is done at manufacturing level, and not with the end user.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein.

### REFERENCE SIGNS LIST

1. aerosol-generating device (first embodiment)
2. battery
3. first housing portion
4. removable ring/cap (second housing portion)
5. bayonet joint
6. receptacle with opening
7. removable internal unit
8. torque engaging structure (of ring 4)
9. power consuming unit
10. battery compartment/power supply unit
11. electronics unit
12. aerosol-generating article receiving cavity within an aerosol generating compartment in the form of a tubular coil
13. main button
14. internal electrical interface
15. bottom cap of battery compartment 10
16. concentrically rings (interconnection electrodes)
17. spring-biased protruding electric terminals (protruding electric terminals)
18. torque engaging structure of bottom cap 15, torx opening
19. bottom end of first housing portion 3
20. external electrical interface
21. charging/companion device
22. torque engaging structure of first housing portion 1 with a recessed flower-shaped pattern
23. battery compartment according to a second aspect
24. electric circuity
25. SIM(identification item)
26. I/O interface (e.g., COM)
27. Processor of battery compartment 10/supply unit 10
28. Processor of power consuming unit 9
100. main axis/longitudinal axis/center axis
101. aerosol-generating device (second embodiment)
103. first housing portion
104. second housing portion
105. male thread
106. female thread
201. aerosol-generating device (third embodiment)
203. first housing portion
204. second housing portion
205. male thread
206. female thread

1.-11. (canceled)

12. An aerosol-generating device, comprising:
a power supply unit configured to supply power for operation of the aerosol-generating device to generate an aerosol, wherein the power supply unit comprises a battery compartment configured to removably hold a battery;
an aerosol-generating compartment comprising an aerosol-generating-article-receiving cavity configured to removably receive an aerosol-generating article; and
two removably attachable housing portions configured to be selectively arranged in any one of at least two different states, including an attached state, in which the two removably attachable housing portions are attached to each other, and a detached state, in which the two removably attachable housing portions are detached from each other,
wherein a first housing portion is configured to accommodate the power supply unit and the aerosol-generating compartment,
wherein a second housing portion is a removable cap configured to secure the aerosol-generating compartment within the first housing portion in the attached state,
wherein transferring the first and the second housing portions from the attached state to the detached state enables replacement of the battery, and
wherein the removable cap has a form of a ring element with an opening configured to access the aerosol-generating article-receiving cavity in the attached state.

13. The aerosol-generating device according to claim 12, wherein the two removably attachable housing portions are configured to be attached to each other by a bayonet joint or a threaded joint.

14. The aerosol-generating device according to claim 12, wherein a housing comprises at least one torque engaging structure configured to engage with a matching torque tool for applying torque to the housing.

15. The aerosol-generating device according to claim 12, wherein a housing comprises an external electrical and/or mechanical interface that is electrically and/or mechanically connectable to an external device.

16. The aerosol-generating device according to claim 15, wherein the external device is a charging device or a docking station.

17. The aerosol-generating device according to claim 12, wherein a housing comprises an internal electrical and/or mechanical interface that is electrically and/or mechanically connectable to the battery compartment or power supply unit.

18. The aerosol-generating device according to claim 12, wherein the battery compartment or power supply unit is removably accommodated in the housing.

19. The aerosol-generating device according to claim 12,
wherein the power-supply unit further comprises an identification item,
wherein the aerosol-generating device further comprises an identification unit configured to identify the power-supply unit by means of the identification item.

20. An aerosol-generating system comprising the aerosol-generating device according to claim 12 and a charging device configured to charge the power supply unit of the aerosol-generating device.

21. A method for replacing the battery of an aerosol-generating device according to claim 12, the method comprising the following steps:
a. opening the housing;
b. removing the battery from the battery compartment of the power supply unit,
c. inserting a replacement battery into the battery compartment; and
d. closing the housing.
